(19) United States
(12) Patent Application Publication
(10) Pub. No.: US 2008/0095975 A1
(43) Pub. Date: Apr. 24, 2008

(54) POLYCRYSTALLINE SILICON THIN FILM AND METHOD FOR FORMING THE SAME

(76) Inventors: Jin Jang, Seoul (KR); Jun-Hyuk Cheon, Seoul (KR); Kyung-Ho Kim, Seoul (KR)

Correspondence Address: KED & ASSOCIATES, LLP, P.O. Box 221200, Chantilly, VA, 20153-1200, US

(21) Appl. No.: 11/875,145

(22) Filed: Oct. 19, 2007

(30) Foreign Application Priority Data
Oct. 23, 2006 (KR) 10-2006-0102823
Apr. 20, 2007 (KR) 10-2007-0038714

(51) Int. Cl. B05D 5/12; B32B 5/12

(52) U.S. Cl. 428/105; 427/576; 427/123; 427/124

(57) ABSTRACT

A polycrystalline silicon thin film having grains defined by grain boundaries is provided. The polycrystalline silicon thin film is formed by interposing a cover layer between an amorphous silicon layer and a metal layer to diffuse the metal into the amorphous silicon layer through the cover layer, removing the cover layer, crystallizing the amorphous silicon layer to be changed to a polycrystalline silicon layer, depositing a metal on the polycrystalline silicon layer, and annealing the polycrystalline silicon layer. Specifically, the polycrystalline silicon thin film is formed by sequentially forming an amorphous silicon layer, a cover layer and a metal layer on an insulating substrate, annealing the amorphous silicon layer to be changed to a polycrystalline silicon layer, removing the cover layer, depositing a metal on the polycrystalline silicon layer, followed by annealing so that the average density per unit volume of the metal particles present at the grain boundaries is greater than that of the metal particles present within the grains.

### BACKGROUND OF THE INVENTION

1. Field of the Invention

The present invention relates to a polycrystalline silicon thin film. More specifically, the present invention relates to a polycrystalline silicon thin film that is formed by interposing a cover layer between an amorphous silicon layer and a metal layer to diffuse the metal into the amorphous silicon layer through the cover layer, removing the cover layer, crystallizing the amorphous silicon layer to be changed to a polycrystalline silicon layer, depositing a metal on the polycrystalline silicon layer, followed by annealing, thereby protecting the polycrystalline silicon thin film from being contaminated with the metal and impurities that may arise during annealing, keeping the surface of the polycrystalline silicon thin film clean and markedly decreasing the surface roughness of the polycrystalline silicon thin film due to the formation of the cover layer protecting the surface of the amorphous silicon layer, and allowing the metal particles deposited on the polycrystalline silicon layer to migrate to the silicon grain boundaries to control the growth of the silicon grains.

2. Description of the Related Art

Thin film transistors (TFTs) are switching elements that use a polycrystalline silicon thin film as an active layer. Thin film transistors are typically used as active devices for active matrix liquid crystal displays and switching elements for electroluminescent devices. Thin film transistors are also used in peripheral circuits of active matrix liquid crystal displays and electroluminescent devices.

General thin film transistors are fabricated using a direct deposition, high-temperature annealing or laser annealing technique. Advantages of laser annealing techniques are that crystallization (hereinafter, also referred to as ‘phase change’) is possible even at temperatures as low as 400° C. and high field effect mobility can be achieved. Based on these advantages, laser annealing techniques are employed in preference to direct deposition and high-temperature annealing techniques. However, laser annealing techniques present the problems of non-uniform phase change and low productivity and require the use of expensive equipment, thus being unsuitable for the formation of polycrystalline silicon on large-area substrates.

Another approach to crystallize amorphous materials, particularly, amorphous silicon, is solid-phase crystallization using low-price equipment to produce crystals through uniform phase change. However, according to solid-phase crystallization, a long time is required for crystallization, thus causing low productivity, and a high temperature is needed for crystallization, thus making it impossible to use glass substrates.

On the other hand, phase change processes of amorphous materials using metals are known. Since the phase change processes provide an advantage in that phase change is possible at a relatively low temperature within a relatively short time when compared to solid-phase crystallization, extensive research on the phase change processes is actively underway. One of the phase change processes is metal-induced crystallization.

Metal-induced crystallization is a process wherein a particular kind of metal is in direct contact with at least one portion of a thin film composed of an amorphous material to change the phase of the amorphous material in the lateral directions from the contact portion between amorphous material and the metal or a metal is doped within a thin film composed of an amorphous material to change the phase of the amorphous material from the contact portions between the amorphous material and the doped metal.

According to the prior art processes, device characteristics may be deteriorated due to the possibility of contamination with metals, and therefore, additional processing for the removal of the contaminated portions is involved, resulting in a drastic reduction in productivity.

In the case where a thin film is formed in source and/or drain regions of a thin film transistor using an amorphous material by patterning, the amorphous material undergoes incomplete phase change and remains in the source and/or drain regions.

That is, although the metal-induced crystallization of amorphous materials has the advantage that the crystallization temperature can be lowered, there is a problem in that thin films undergoing phase change may be contaminated with metals incorporated therein, causing deterioration of characteristics inherent to the thin films.

Minimization of contamination of thin films with metals is a prerequisite for the use of metal-induced crystallization of amorphous materials. Reduction in the amount of metals used is most important to minimize the contamination of thin films with the metals. Under these circumstances, some methods for changing the phase of amorphous materials using reduced amounts of metals have been proposed. For example, the phase of an amorphous material is changed by depositing a metal ion at a concentration of 1×10¹⁴ to 1×10¹⁶ cm⁻² using an ion implanter or depositing a thin film to a thickness as small as about 5 Å, followed by high-temperature processing, rapid thermal annealing or laser irradiation. In the prior art metal-induced crystallization, a mixture of a viscous organic thin film and a liquid-phase metal is spin-coated to form a thin film, followed by annealing to change the phase of an amorphous material.

According to the proposed methods, however, contamination of the thin films with metals cannot be significantly reduced and problems remain unsolved in terms of large-size and uniform grains and large-area thin films.

### SUMMARY OF THE INVENTION

The present invention has been made in an effort to solve the problems of the prior art, and it is an object of the present invention to provide a polycrystalline silicon thin film that is formed by interposing a cover layer between an amorphous silicon layer and a metal layer to diffuse the metal into the amorphous silicon layer through the cover layer, removing the cover layer, crystallizing the amorphous silicon layer to be changed to a polycrystalline silicon layer, depositing a metal on the polycrystalline silicon layer, followed by annealing, thereby protecting the polycrystalline silicon thin film from being contaminated with the metal and impurities that may arise during annealing, keeping the surface of the polycrystalline silicon thin film clean and markedly decreasing the surface roughness of the polycrystalline silicon thin film due to the formation of the cover layer protecting the surface of the amorphous silicon layer, and allowing the metal particles deposited on the polycrystalline silicon layer to migrate to the silicon grain boundaries to control the growth of the silicon grains.

In order to accomplish the above object of the present invention, there is provided a polycrystalline silicon thin film having grains defined by grain boundaries wherein the polycrystalline silicon thin film is formed by sequentially forming an amorphous silicon layer and a metal layer on an insulating substrate and crystallizing the amorphous silicon layer by annealing so that the average density per unit volume of the metal particles present at the grain boundaries is greater than that of the metal particles present within the grains.

According to an embodiment of the present invention, there is provided a polycrystalline silicon thin film having grains defined by grain boundaries wherein the polycrystalline silicon thin film is formed by sequentially forming an amorphous silicon layer, a cover layer and a metal layer on an insulating substrate, annealing the amorphous silicon layer to be changed to a polycrystalline silicon layer, removing the cover layer, depositing a metal on the polycrystalline silicon layer, followed by annealing so that the average density per unit volume of the metal particles present at the grain boundaries is greater than that of the metal particles present within the grains.

The insulating substrate is preferably selected from single-crystal wafers covered with glass, quartz or an oxide film and flexible metal substrates covered with an insulating film.

The insulating film is preferably laminated with at least one film selected from silicon oxide films, silicon nitride films, silicon oxynitride films, silicate films and organic films.

The metal layer is preferably formed by ion implantation, plasma enhanced chemical vapor deposition (PECVD), sputtering, spin coating, printing or dipping.

The metal is preferably nickel (Ni).

The polycrystalline silicon thin film preferably has polycrystalline grains that are grown into a disk shape to have a polygonal structure.

The average density per unit volume of the metal particles present at the boundaries between the grains of the polycrystalline silicon thin film is preferably greater than that of the metal particles present within the grains.

The average density per unit volume of the metal particles present in the central regions of the grains is preferably greater than that of the metal particles present in the entire region of the grains.

The grain boundaries are preferably linear.

The grains preferably have a diameter of 5 to 100 μm.

According to the present invention, there is provided a method for forming a polycrystalline silicon thin film, the method comprising the steps of: depositing an amorphous silicon layer on an insulating substrate and incorporating a metal into the amorphous silicon layer; annealing the amorphous silicon layer to nucleate the metal particles and allowing the nuclei to migrate in the lateral directions of the silicon grains so that the amorphous silicon layer is crystallized to be changed to a polycrystalline silicon layer; and allowing the grains of the polycrystalline silicon layer to collide with one another to form grain boundaries.

The metal particles contained in the amorphous silicon layer preferably have an areal density of 1×10¹² to 1×10¹⁴ cm⁻². The metal is preferably nickel (Ni).

The grain boundaries formed by the collision of the grains are preferably linear.

### BRIEF DESCRIPTION OF THE DRAWINGS

FIG. 1 is a process flow diagram of a method for forming a polycrystalline silicon thin film according to the present invention.

FIGS. 2a and 2b are photographs showing the distributions of metal particles in polycrystalline silicon thin films of the prior art and the present invention, respectively, as analyzed by secondary ion mass spectroscopy based on the time-of-flight method.

FIGS. 3a and 3b are optical micrographs of a polycrystalline silicon thin film according to the present invention at different magnifications.

FIG. 4a is an optical micrograph of polycrystalline silicon grains containing no amorphous silicon in the central regions and a cross-sectional diagram of one of the grains, FIG. 4b is a schematic diagram illustrating the distribution of metal particles in the disk-shaped grain after crystallization, and FIG. 4c is a schematic diagram illustrating the distribution of the metal particles in the crystallized polycrystalline silicon grain after annealing.

FIG. 5a is a schematic diagram illustrating the formation of a metal layer on a polycrystalline silicon layer, FIG. 5b is a schematic diagram illustrating the diffusion of the metal particles during annealing, and FIG. 5c is a schematic diagram illustrating the diffusion of the metal particles into grain boundaries of the polycrystalline silicon layer after annealing to grow the grains.

### DESCRIPTION OF THE PREFERRED EMBODIMENTS

Preferred embodiments of a polycrystalline silicon thin film according to the present invention will now be described in greater detail with reference to the accompanying drawings.

The present invention provides a polycrystalline silicon thin film having grains defined by grain boundaries wherein the polycrystalline silicon thin film is formed by sequentially forming an amorphous silicon layer and a metal layer on an insulating substrate and crystallizing the amorphous silicon layer by annealing so that the average density per unit volume of the metal particles present at the grain boundaries is greater than that of the metal particles present within the grains. That is, the polycrystalline silicon thin film of the present invention is characterized in that the grains are clearly distinguished from one another.

In one embodiment, the present invention provides a polycrystalline silicon thin film having grains defined by grain boundaries wherein the polycrystalline silicon thin film is formed by sequentially forming an amorphous silicon layer, a cover layer and a metal layer on an insulating substrate, annealing the amorphous silicon layer to be changed to a polycrystalline silicon layer, removing the cover layer, depositing a metal on the polycrystalline silicon layer, followed by annealing so that the average density per unit volume of the metal particles present at the grain boundaries is greater than that of the metal particles present within the grains. That is, the polycrystalline silicon thin film according to the embodiment of the present invention is characterized in that the grains are more clearly distinguished from one another through the two annealing steps.

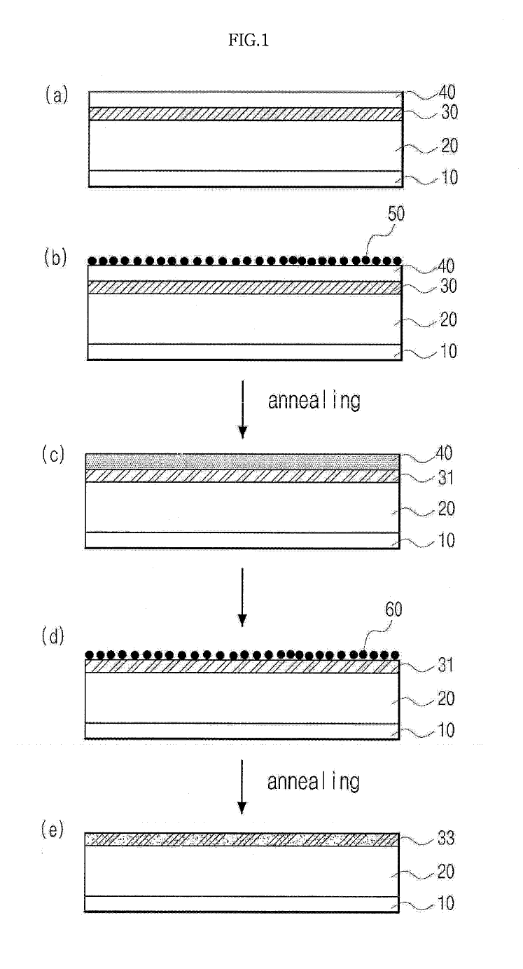

FIG. 1 is a process flow diagram of a method for forming the polycrystalline silicon thin film according to the present invention. Hereinafter, an explanation will be made for the polycrystalline silicon thin film that uses a cover layer and is formed through two annealing steps. It should be appreciated that those skilled in the art can conceive a method for forming the polycrystalline silicon thin film having grains clearly discernable from one another through one annealing step only without using any cover layer.

First, as shown in FIG. 1a, an insulating substrate 10, a buffer layer 20, an amorphous silicon layer 30 and a cover layer 40 are deposited in this order. Then, as shown in FIG. 1b, a metal 50 is directly deposited on top of the cover layer 40.

The insulating substrate 10 is not especially limited. Taking into consideration the temperature required to crystallize the amorphous silicon layer and the uniformity of the final thin film, the insulating substrate 10 is preferably selected from single-crystal wafers covered with glass, quartz or an oxide film. The insulating substrate 10 may be a flexible metal substrate having an insulating film formed thereon.

The buffer layer 20 is not an essential element and may be omitted. The use of the buffer layer 20 to form the final thin film is more preferred.

The amorphous silicon layer 30 is preferably formed by a technique selected from sputtering, chemical vapor deposition and pyrolysis. The amorphous silicon layer 30 may contain various amorphous materials other than amorphous silicon.

The cover layer 40 plays a role in uniformly diffusing the metal 50 into the amorphous silicon layer 30 and protecting the final thin film from being contaminated with unnecessary organic materials and the metal.

Each of the buffer layer 20, the cover layer 40 and the insulating film formed on the metal substrate may be one or more films selected from a silicon oxide film, a silicon nitride film, a silicon oxynitride film, a silicate film and an organic film. That is, each layer has a monolayer structure or a multilayer laminate structure consisting of two or more identical or different films.

The silicon nitride film is formed by chemical vapor deposition using silane (SiH₄), ammonia and nitrogen gases. Alternatively, the silicon nitride film may be formed by sputtering using a nitride film as a target.

A nitride film having a thickness of 350 nm may be used as the cover layer through which the metal is allowed to be diffused, but tends to be broken during annealing at 600° C. or laser irradiation due to its poor heat resistance.

The silicon oxide film is generally formed by blowing oxygen at a high temperature, by chemical vapor deposition using silane (SiH₄) and oxygen, or by sputtering using an oxide film as a target. The metal is not readily diffused through a silicon oxide film having a thickness of 10 nm or more as the cover layer. Accordingly, the thickness of the silicon oxide film is limited to several nanometers.

The silicon oxynitride film is formed by chemical vapor deposition using silane (SiH₄), ammonia or nitrogen as a nitrogen source and nitric oxide or oxygen as an oxygen source. Alternatively, the silicon oxynitride film may be formed by sputtering using an oxynitride film as a target.

An oxynitride film having a thickness of 350 nm may be used as the cover layer through which the metal is allowed to be diffused, like the nitride film, and is not broken at a high temperature, unlike the nitride film. This is because the oxynitride film is strengthened due to the presence of oxygen bonds in a general nitride film. Consequently, the use of the oxynitride film as the cover layer can prevent the cover layer from being broken even upon annealing at 600° C. or higher or laser irradiation.

The cover layer 40 is preferably formed to a thickness ranging from 0.1 to 1,000 nm at a temperature of 650° C. or lower. Non-limiting techniques that can be employed to form the cover layer 40 include plasma enhanced chemical vapor deposition (PECVD), chemical vapor deposition (CVD), pyrolysis-based deposition, printing and spin coating. PECVD is most preferred.

The metal 50 deposited on top of the cover layer 40 functions as a mediator or inducer for the crystallization of the amorphous material. The metal 50 is preferably deposited to a thickness of 0.001 to 1,000 nm.

Various instruments and techniques may be employed to deposit the metal 50 on top of the cover layer 40. For example, an ion implanter, a shadow mask or a metal-containing gas is used for the deposition of the metal 50. PECVD, CVD, atomic layer deposition (ALD), sputtering, coating using a solution of a liquid-phase metal in an acid solution, spin coating using a mixture of an organic film and a liquid-phase metal, printing or dipping may be employed for the deposition of the metal 50. It is to be understood that the present invention is not particularly limited to the above instruments and techniques.

The metal layer 50 formed on top of the cover layer 40 is preferably in the form of a thin film having an areal density of 1×10¹² to 1×10¹⁸ cm⁻². The metal 50 may be selected from nickel (Ni), cobalt (Co), palladium (Pd), platinum (Pt), iron (Fe), copper (Cu), silver (Ag), gold (Au), indium (In), lead (Sn), arsenic (As), antimony (Sb), and alloys thereof. Most preferred is nickel (Ni).

It is difficult to deposit the metal 50 to form a uniform thin film having a thickness of 0.2 nm or less. To overcome this difficulty, the metal 50 is deposited to a thickness of 0.2 to 1,000 nm and etched to have a desired thickness of 0.2 nm or less.

Thereafter, the amorphous silicon layer 30 undergoes crystallization. This crystallization is conducted by supplying external heat energy to the amorphous silicon layer 30 to diffuse the metal 50 into the amorphous silicon layer 30. The diffused metal particles function as media to grow the silicon grains of the amorphous silicon layer.

The supply of the heat energy is achieved by annealing, rapid thermal annealing, laser or UV irradiation, etc. Annealing is performed to crystallize the amorphous silicon layer 30 in the method of the present invention.

The annealing is preferably performed in the temperature range between 200 and 1,400° C. Examples of suitable devices for the annealing include, but are not limited to, halogen lamps, UV lamps and furnaces.

The crystallization of the amorphous silicon layer 30 may be conducted in a state where an electric, magnetic or electromagnetic field is applied.

The annealing is preferably performed in the temperature range of 200 to 1,400° C. to crystallize the amorphous silicon layer 30. Within this temperature range, rapid thermal annealing and long-term thermal annealing may be employed separately or simultaneously.

The rapid thermal annealing is a process in which annealing is performed several times in the temperature range of 500 to 900° C. for several tens of seconds, and the long-term thermal annealing is a process in which annealing is performed in the temperature range of 400 to 500° C. for at least one hour. The annealing temperature ranges are not absolute and may be optionally varied for the thermal annealing processes.

As shown in FIG. 1c, annealing is conducted to allow the metal 50 to be diffused into the cover layer 40 and form precipitates within the amorphous silicon layer 30. As a result, the amorphous silicon layer 30 is crystallized. As for amorphous silicon, metal disilicide (MSi₂) nuclei are precipitated.

The silicon grains are grown in the lateral directions from the nuclei. Grain boundaries are formed between the adjacent grains to change the amorphous silicon layer 30 to a polycrystalline silicon layer 31. The grains are continuously grown until they are in contact with the adjacent grains. The crystallization of the amorphous silicon layer is completed when further growth of the grains is impossible.

That is, the amorphous silicon layer is annealed to nucleate the metal particles and allow the metal the nuclei to migrate in the lateral directions. As a result, the amorphous silicon layer is crystallized to be changed to a polycrystalline silicon layer. The grains of the polycrystalline silicon layer collide with one another to form grain boundaries.

It is preferred that the metal particles contained in the amorphous silicon layer have an areal density of 1×10¹² to 1×10¹⁴ cm⁻² and the grain boundaries formed by the collision of the grains be linear.

The thickness of the polycrystalline silicon layer is preferably in the range of 15 to 150 nm. The polycrystalline silicon thin film has polycrystalline grains that are grown into a disk shape to have a polygonal structure.

After completion of the crystallization, the metal 50 and the cover layer 40 are removed by etching. A metal layer 60 is formed on the polycrystalline silicon layer 31 (FIG. 1d), followed by annealing to form the final polycrystalline silicon thin film 33 (FIG. 1e). The grains of the polycrystalline silicon thin film 33 are larger in size than the grains of the polycrystalline silicon layer shown in FIG. 1c.

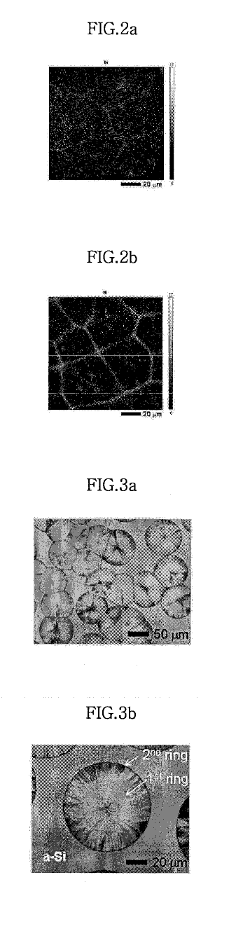

FIGS. 2a and 2b are photographs showing the distributions of metal particles in polycrystalline silicon thin films of the prior art and the present invention, respectively, as analyzed by secondary ion mass spectroscopy based on the time-of-flight method. As shown in FIG. 2b, the metal particles are collected in regions where the silicon grains are grown and collide with one another. In contrast, unclear grain boundaries are shown in FIG. 2b. That is, grain boundaries are more clearly distinguished in the polycrystalline silicon thin film of the present invention, indicating that most of the metal particles migrate to the grain boundaries of the polycrystalline silicon thin film during annealing.

The polycrystalline grains of the polycrystalline silicon thin film according to the present invention are grown into a disk shape to have a polygonal structure.

As a result, the average density per unit volume of the metal particles present at the grain boundaries of the polycrystalline silicon thin film is greater than that of the metal particles present within the grains. This result reveals that most of the metal particles migrate to the grain boundaries.

In addition, the average density per unit volume of the metal particles present in the central regions of the grains is greater than that of the metal particles present in the entire region of the grains. The central regions account for one-third or less of the entire region of the grains. The metal particles acting as nuclei remain in the central regions of the grains, and the other metal particles migrate to the grain boundaries.

On the other hand, the shape of the grain boundaries is linear and the size (diameter) of the grains is in the range of 5 to 100 μm, preferably 10 to 50 μm.

FIGS. 3a and 3b are optical micrographs of the final polycrystalline silicon thin film according to the present invention at different magnifications. Specifically, the polycrystalline silicon thin film is formed by depositing the metal particles in an amount of 8.47×10¹³ cm⁻² on the amorphous silicon layer, crystallizing the amorphous silicon layer at 500° C. for 30 hours, removing the cover layer, forming a metal (e.g., Ni) layer, followed by annealing at 560° C. for 25 hours.

As shown in FIG. 3b, a first grain is formed by the first annealing (FIG. 1c) and is grown into a second grain at the boundary of the first grain by annealing after the second metal deposition (FIG. 1e). The grain formed after the first crystallization has a size of 5 to 58 μm and is grown to a size of 5 to 20 μm at the boundary of the first grain after the second annealing.

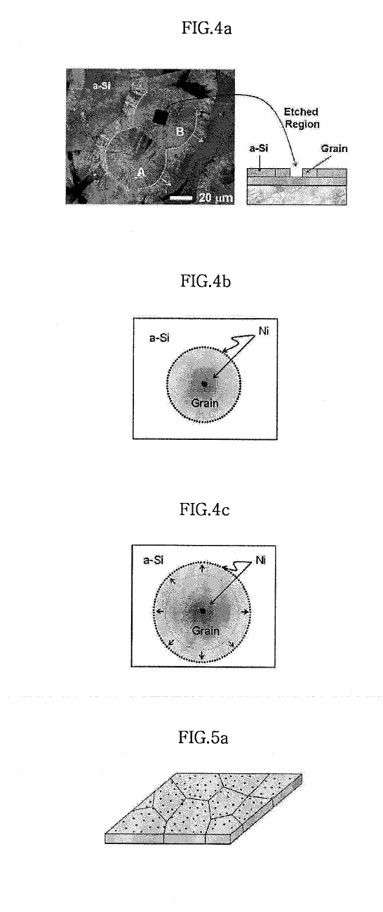

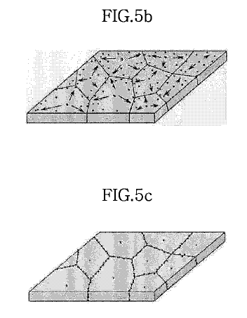

FIG. 4a is an optical micrograph of the polycrystalline silicon grains containing no amorphous silicon in the central regions and a cross-sectional diagram of one of the grains. In FIG. 4a, amorphous silicon is absent in the box-shaped “B” region and is present in the “A” region. After crystallization, this sample is annealed at 560° C. for 7 hours. FIG. 4b is a schematic diagram illustrating the distribution of the metal particles in the disk-shaped grain after crystallization, and FIG. 4c is a schematic diagram illustrating the distribution of the metal particles in the crystallized polycrystalline silicon grain after annealing.

FIGS. 5a, 5b and 5c are schematic diagrams illustrating the distribution and diffusion of the metal (Ni) particles within the polygonal polycrystalline silicon grains. Specifically, FIG. 5a illustrates the formation of the metal (Ni) layer on the polycrystalline silicon layer, FIG. 5b illustrates the diffusion of the metal (Ni) particles during the second annealing, and FIG. 5c illustrates the migration of the metal (Ni) particles to the grain boundaries. The arrows shown in FIG. 5b represent the migration direction of the metal particles. As a result, the grain boundaries are more clearly distinguished (FIG. 5c).

As apparent from the foregoing features and preferred embodiments, the polycrystalline silicon thin film of the present invention is formed by interposing a cover layer between an amorphous silicon layer and a metal layer to diffuse the metal into the amorphous silicon layer through the cover layer, removing the cover layer, crystallizing the amorphous silicon layer to be changed to a polycrystalline silicon layer, depositing a metal on the polycrystalline silicon layer, and annealing the polycrystalline silicon layer. With this configuration, the polycrystalline silicon thin film of the present invention is protected from being contaminated with the metal and impurities that may arise during annealing. In addition, the surface of the polycrystalline silicon thin film is kept clean and the surface roughness of the polycrystalline silicon thin film is markedly decreased due to the formation of the cover layer protecting the surface of the amorphous silicon layer. Furthermore, the metal particles deposited on the polycrystalline silicon layer are allowed to migrate to the silicon grain boundaries to control the growth of the silicon grains.

According to the method of the present invention, phase change and a metal (e.g., Ni) are used to control the growth of polycrystalline silicon grains into macroscopic grains. As a result, a uniform polycrystalline silicon thin film can be formed. Therefore, the method of the present invention can replace laser techniques. In addition, a polycrystalline silicon thin film formed by the method of the present invention can be effectively used for the fabrication of a variety of devices, including flat panel display devices, solar cells and semiconductor devices.

What is claimed is:

1. A polycrystalline silicon thin film having grains defined by grain boundaries wherein the polycrystalline silicon thin film is formed by sequentially forming an amorphous silicon layer and a metal layer on an insulating substrate and crystallizing the amorphous silicon layer by annealing so that the average density per unit volume of the metal particles present at the grain boundaries is greater than that of the metal particles present within the grains.

2. A polycrystalline silicon thin film having grains defined by grain boundaries wherein the polycrystalline silicon thin film is formed by sequentially forming an amorphous silicon layer, a cover layer and a metal layer on an insulating substrate, annealing the amorphous silicon layer to be changed to a polycrystalline silicon layer, removing the cover layer, depositing a metal on the polycrystalline silicon layer, followed by annealing so that the average density per unit volume of the metal particles present at the grain boundaries is greater than that of the metal particles present within the grains.

3. The polycrystalline silicon thin film according to claim 1, wherein the insulating substrate is selected from single-crystal wafers covered with glass, quartz or an oxide film and flexible metal substrates covered with an insulating film.

4. The polycrystalline silicon thin film according to claim 1, wherein the metal is nickel (Ni).

5. The polycrystalline silicon thin film according to claim 1, wherein the polycrystalline silicon thin film has polycrystalline grains that are grown into a disk shape to have a polygonal structure.

6. The polycrystalline silicon thin film according to claim 5, wherein the average density per unit volume of the metal particles present in the central regions of the grains is greater than that of the metal particles present in the entire region of the grains.

7. The polycrystalline silicon thin film according to claim 5, wherein the average density per unit volume of the metal particles present at the grain boundaries between the grains of the polycrystalline silicon thin film is greater than that of the metal particles present within the grains.

8. The polycrystalline silicon thin film according to claim 5, wherein the grain boundaries are linear.

9. The polycrystalline silicon thin film according to claim 5, wherein the grains have an average diameter of 5 to 100 μm.

10. The polycrystalline silicon thin film according to claim 9, wherein the grains have an average diameter of 10 to 50 μm.

11. The polycrystalline silicon thin film according to claim 1, wherein a buffer layer is disposed between the insulating substrate and the amorphous silicon layer.

12. The method according to claim 1, wherein the metal layer is formed by a technique selected from ion implantation, chemical vapor deposition (CVD), sputtering, spin coating, printing, plasma enhanced chemical vapor deposition (PECVD), atomic layer deposition (ALD) and dipping.

13. A method for forming a polycrystalline silicon thin film, the method comprising the steps of:
depositing an amorphous silicon layer on an insulating substrate and incorporating a metal into the amorphous silicon layer;
annealing the amorphous silicon layer to nucleate the seeds and allowing the nuclei to migrate in the lateral directions of the silicon grains so that the amorphous silicon layer is crystallized to be changed to a polycrystalline silicon layer; and
allowing the grains of the polycrystalline silicon layer to collide with one another to form grain boundaries.

14. The method according to claim 13, wherein the metal particles contained in the amorphous silicon layer have an areal density of 1×10¹² to 1×10¹⁴ cm⁻².

15. The method according to claim 14, wherein the metal is nickel (Ni).

16. The method according to claim 13, wherein the grain boundaries formed by the collision of the grains are linear.

17. The method according to claim 13, wherein the metal layer is formed by a technique selected from ion implantation, chemical vapor deposition (CVD), sputtering, spin coating, printing, plasma enhanced chemical vapor deposition (PECVD), atomic layer deposition (ALD) and dipping.

18. The method according to claim 13, wherein the polycrystalline silicon thin film has polycrystalline grains that are grown into a disk shape to have a polygonal structure.

19. The method according to claim 13, wherein the average density per unit volume of the metal particles present in the central regions of the grains is greater than that of the metal particles present in the entire region of the grains.

20. The method according to claim 13, wherein the average density per unit volume of the metal particles present at the grain boundaries between the grains of the polycrystalline silicon thin film is greater than that of the metal particles present within the grains.

21. The method according to claim 13, wherein the grains have an average diameter of 5 to 100 μm.
